(19) United States
(12) Patent Application Publication
(10) Pub. No.: US 2003/0009891 A1
(43) Pub. Date: Jan. 16, 2003

(54) Laser sighting device

(76) Inventors: Fumio Ohtomo, Tokyo-to (JP); Jun-Ichi Kodaira, Tokyo-to (JP)

Correspondence Address: Kevin S. Lemack, Nields & Lemack, 176 E. Main Street, Westboro, MA, 01581, US

(21) Appl. No.: 10/180,880

(22) Filed: Jun. 26, 2002

(30) Foreign Application Priority Data
Jul. 13, 2001 (JP) JP2001-214095

(51) Int. Cl. G01C 15/00

(52) U.S. Cl. 33/286

(57) ABSTRACT

A laser sighting device, comprising a light emitter holder, a rotator holder rotatably mounted on the light emitter holder, a laser light source mounted on the light emitter holder and for emitting a laser beam on an emitted light optical axis along a rotation center of the rotator holder, and an optical path deflecting component mounted on the rotator holder and for deflecting the laser beam projected from the laser light source in a direction perpendicular to the emitted light optical axis.

### BACKGROUND OF THE INVENTION

The present invention relates to a laser sighting device, and in particular, to a simplified type laser sighting device using a rod lens and for projecting a laser beam in fan-like shape.

A laser sighting device is used to form a reference plane for operations in construction work or civil engineering work. As a simplified type laser sighting device, a laser sighting device using a rod lens is known. This simplified type laser sighting device has a simple function and is available at low cost.

Referring to FIG. 6 and FIG. 7, description will be given below on a conventional type laser sighting device.

A base unit 2 is mounted on a leveling base 1, and a frame 4 is rotatably mounted on the base unit 2 via bearings 3.

The leveling base 1 comprises a base seat 5 and three leveling screws 6. By turning the leveling screws 6 at adequate positions, it is possible to perform horizontal positioning of the base unit 2.

A laser beam projecting unit 7 is provided in the frame 4. The laser beam projecting unit 7 comprises a projected light optical axis 8 running in a direction perpendicular to a rotation axis of the frame 4, and it comprises a light source 9 such as diode laser for emitting a laser beam 13 along the optical axis 8 of the projected light, a collimator lens 11 for turning the laser beam 13 emitted from the light source 9 to a parallel beam, and a rod lens 12 having an optical axis perpendicular to an optical axis of the collimator lens 11 and also perpendicular to the rotation axis of the frame 4.

The laser beam 13 emitted from the emitting light source 9 is turned to a parallel beam by the collimator lens 11 and the beam is spread in a horizontal direction by the rod lens 12 and is then projected through a projection window 14 of the frame 4. To facilitate the explanation, the laser beam 13 spreading in a vertical direction is shown in FIG. 6.

The laser beam 13 is spread in a horizontal direction and is projected as a fan-shaped laser beam and forms a horizontal reference plane. A spread angle of the laser beam 13 is about 100°. When a working position is deviated from the horizontal reference plane, the frame 4 is adequately rotated by hand. Namely, by rotating the frame 4, the horizontal reference plane over total circumference can be obtained.

The accuracy required for the horizontal reference plane is about 10 seconds in angular error.

In the conventional type laser sighting device as described above, the frame 4 is mounted on the base unit 2 via the bearings 3. The bearings 3 itselves have backlash because of the function to rotate. For this reason, the rotation axis is often deviated when the frame 4 is rotated. That is, oscillating of the frame 4 occurs. As a result, the horizontal reference plane formed by the laser beam 13 projected from the frame 4 is also deviated. This results in the problem that it is difficult to have the horizontal reference plane with the accuracy as required.

### SUMMARY OF THE INVENTION

It is an object of the present invention to provide a laser sighting device for forming a reference plane by projecting a laser beam from a rotating mechanism, by which it is possible to form a horizontal reference plane at all times by the projected laser beam even when there is an error in the rotating mechanism.

To attain the above object, the laser sighting device according to the present invention comprises a light emitter holder, a rotator holder rotatably mounted on the light emitter holder, a laser light source mounted on the light emitter holder and for emitting a laser beam on an emitted light optical axis along a rotation center of the rotator holder, and an optical path deflecting component mounted on the rotator holder and for deflecting the laser beam projected from the laser light source in a direction perpendicular to the emitted light optical axis. Also, the present invention provides the laser sighting device as described above, wherein the light emitter holder comprises a rod lens on the rotation center of the rotator holder, and the laser beam deflected by the optical path deflecting member is entered in a direction perpendicular to the center line of the rod lens. Further, the present invention provides the laser sighting device as described above, wherein the optical path deflecting component deflects the laser beam to a perpendicular direction after the laser beam passes through the rod lens in parallel to the center line. Also, the present invention provides the laser sighting device as described above, wherein the optical path deflecting component deflects the laser beam coming from the laser light source in a perpendicular direction and then enters the laser beam toward the rod lens. Further, the present invention provides the laser sighting device as described above, wherein the optical path deflecting component comprises a corner prism and a pentagonal prism. Also, the present invention provides the laser sighting device as described above, wherein the optical path deflecting component comprises a rhombic prism and a pentagonal prism. Further, the present invention provides the laser sighting device as described above, wherein there is further provided a leveling unit, and the light emitter holder is arranged in a direction perpendicular to a horizontal plane leveled by the leveling unit. Also, the present invention provides the laser sighting device as described above, wherein there is further provided a leveling unit, and the light emitter holder is arranged in parallel to a horizontal plane leveled by the leveling unit. Further, the present invention provides the laser sighting device as described above, wherein there is provided a rotating means for rotating the rotator holder.

### BRIEF DESCRIPTION OF THE DRAWINGS

FIG. 1 is a cross-sectional view of a first embodiment of the present invention;

FIG. 2 is a cross-sectional view of an essential portion of a first variation of the first embodiment of the present invention;

FIG. 3 is a cross-sectional view of an essential portion of a second variation of the first embodiment of the present invention;

FIG. 4 is a cross-sectional view of a second embodiment of the present invention;

FIG. 5 is a cross-sectional view of an essential portion of a variation of the second embodiment of the present invention;

FIG. 6 is a cross-sectional view of a conventional type device; and

FIG. 7 is a drawing to explain operation of the conventional type device.

### DETAILED DESCRIPTION OF THE PREFERRED EMBODIMENT

Description will be given below on embodiments of the present invention referring to the drawings.

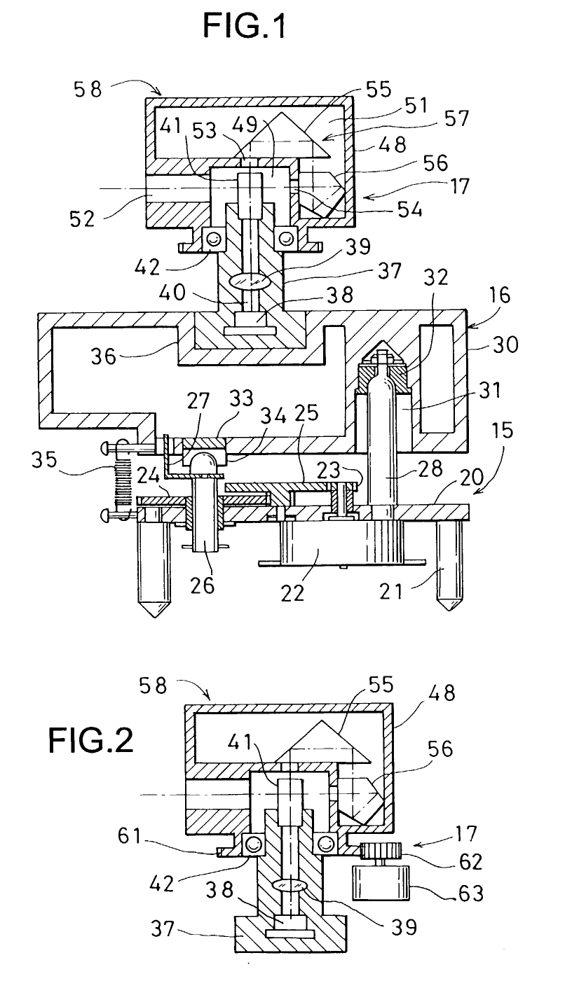

FIG. 1 shows schematical structural features of a first embodiment of the present invention. In the figure, reference numeral 15 denotes a leveling unit, 16 is a main unit, and 17 is a laser beam projecting unit.

Now, description will be given on the leveling unit 15.

A fixed baseplate 20 is supported by four legs 21.

The leveling unit 15 comprises a first tilting mechanism and a second tilting mechanism.

Description will be given below on the first tilting mechanism.

A first tilting motor 22 is provided on the lower surface of the fixed baseplate 20. An output shaft of the first tilting motor 22 is protruded upward, and a first driving gear 23 is engaged on the protruded end. A first driven gear 24 is rotatably mounted on the fixed baseplate 20. The first driven gear 24 is engaged with the first driving gear 23 via a first speed-reducing idle gear 25. At the center of the first driven gear 24, a nut member is formed, in which a first tilting rod 26 is screwed and is penetrating. The upper end of the first tilting rod 26 is protruded and is formed in spherical shape. An L-shaped turn-stop member 27 is fixed on the first tilting rod 26. The turn-stop member 27 is slidably penetrating the bottom of a frame 30 of the main unit 16. It can be moved up or down but is restricted from rotating.

A support pillar 28 is erected on the fixed baseplate 20 and the support pillar 28 is positioned at a predetermined distance from the first tilting rod 26.

A cylindrical recess 31 is formed at the bottom of the frame 30 of the main unit 16, and a spherical seat 32 is provided at the upper end of the cylindrical recess 31. The upper end of the support pillar 28 is designed in semi-spherical shape. The support pillar 28 is inserted into the cylindrical recess 31, and its upper end is rotatably abutted on the spherical seat 32.

Although not shown in the figure, the second tilting mechanism has the same structure as the first tilting mechanism and it is deviated from the first tilting mechanism by rotating it at an angle of 90° around the support pillar 28.

At the bottom of the frame 30, a V-block 33 having a V-groove 34 and a slide guide (not shown) are provided. The upper end of the first tilting rod 26 is slidably abutted on the V-groove 34. The upper end of a second tilting rod (not shown) of the second tilting mechanism is slidably abutted against the slide guide. The central line of the V-groove 34 is arranged in such manner that it passes through the center of the support pillar 28.

The frame 30 is supported at three points, i.e. by the first tilting rod 26, the second tilting rod (not shown), and the support pillar 28. The frame 30 can be tilted in two directions around the support pillar 28.

A spring 35 is stretched between the fixed baseplate 20 and the frame 30 so that the frame 30 is resiliently forced downward. That is, the V-block 33 is pressed against the upper end of the first tilting rod 26, and also the slide guide (not shown) is pressed against the upper end of the second tilting rod (not shown).

When the first tilting motor 22 is driven, the first tilting rod 26 is moved in a vertical direction, and the frame 30 is tilted around the support pillar 28. When the second tilting motor (not shown) is driven, the frame 30 is tilted around the support pillar 28 in a tilting direction perpendicular to the direction of the tilting by the first tilting motor 22. Because the forward end of the first tilting rod 26 is engaged in the V-groove 34, the frame 30 is restricted from rotating in a horizontal direction. By the operation of the first tilting mechanism and the second tilting mechanism, the frame 30 can be accurately tilted in two directions.

On the upper surface of the frame 30, an engaging recess 36 is formed, and the laser beam projecting unit 17 is engaged in the engaging recess 36.

Now, description will be given on the laser beam projecting unit 17.

A light emitter holder 37 is engaged and fitted in the engaging recess 36. A laser light source 38 such as semiconductor laser is provided in the light emitter holder 37, and a collimator lens 39 and a rod lens 41 are arranged on an optical axis 40 of the light emitted from the laser light source 38. The rod lens 41 is positioned in such manner that its central line is aligned with the central line of the optical axis 40 of the emitted light. Further, the lower end of the rod lens 41 is held by the light emitter holder 37, and the portion of the rod lens 41 except the lower end is protruded upward.

On the upper end of the light emitter holder 37, a rotator holder 48 is rotatably mounted via bearings 42. In the rotator holder 48, there are provided a recess 49 to accommodate the rod lens 41, a prism accommodating unit 51 adjacent to the recess 49 and designed in L-shape, and a light exit hole 52 penetrating the recess 49. On the rotator holder 48, an optical path hole 53 is formed on the optical axis 40 of the emitted light to be communicated with the prism accommodating unit 51, and an optical path hole 54 is formed on the central line of the light exit hole 52 to be communicated with the prism accommodating unit 51.

In the prism accommodating unit 51, there are provided a corner prism 55 on the optical axis 40 of the emitted light and a pentagonal prism 56 which faces the corner prism 55 and is positioned on the central line of the optical path hole 54.

The collimator lens 39, the rod lens 41, the corner prism 55, and the pentagonal prism 56 make up together a projecting optical system 57. In particular, the corner prism 55 and the pentagonal prism 56 make up together an optical path deflecting component. The rotator holder 48, the corner prism 55, and the pentagonal prism 56 make up together a rotator 58.

In the following, description will be given on operation.

The laser sighting device is arranged at a predetermined position, and leveling operation of the main unit 16 is performed by the leveling unit 15.

A tilt detector such as electric type bubble tube is arranged on the main unit 16. Based on the result of detection by the tilt detector, the first tilting motor 22 and the second tilting motor (not shown) are driven, and horizontal positioning of the main unit 16 is performed.

When the leveling operation of the main unit 16 is completed, the laser light source 38 is driven, and a laser beam is projected.

The laser beam projected from the laser light source 38 is turned to a parallel beam by the collimator lens 39. After passing through the rod lens 41, the beam enters the corner prism 55. By the corner prism 55, the beam is reflected in a direction parallel to the emitted light optical axis 40 and enter the pentagonal prism 56. The pentagonal prism 56 reflects the laser beam in a direction perpendicular to the incident light optical axis. That is, the laser beam is deflected to a direction perpendicular to the emitted light optical axis 40 and is projected. After passing through the rod lens 41, the laser beam is turned to a fan-shaped light beam and is projected through the light exit hole 52. By the laser beam, a fan-shaped horizontal reference plane is formed. When the laser beam is projected to an object such as wall, a horizontal reference line is formed.

Next, when the position of the horizontal reference plane or the horizontal reference line thus formed is to be changed, the rotator 58 is manually rotated at an adequate angle. The projecting direction of the laser beam is changed, and the position of the horizontal reference plane or the horizontal reference line is changed.

The rotator 58 is rotated via the bearings 42. The bearings have backlash although in slight degree. When the rotator 58 is rotated, an incident angle of the laser beam to the corner prism 55 may be slightly changed.

As described above, the corner prism 55 and the pentagonal prism 56 project the laser beam always in a direction perpendicular to the emitted light optical axis 40. Accordingly, if the main unit 16 is adjusted by the leveling unit 15 in such manner that the emitted light optical axis 40 is directed vertically, it is possible to obtain a horizontal reference plane regardless of whether the bearings 42 have backlash or not.

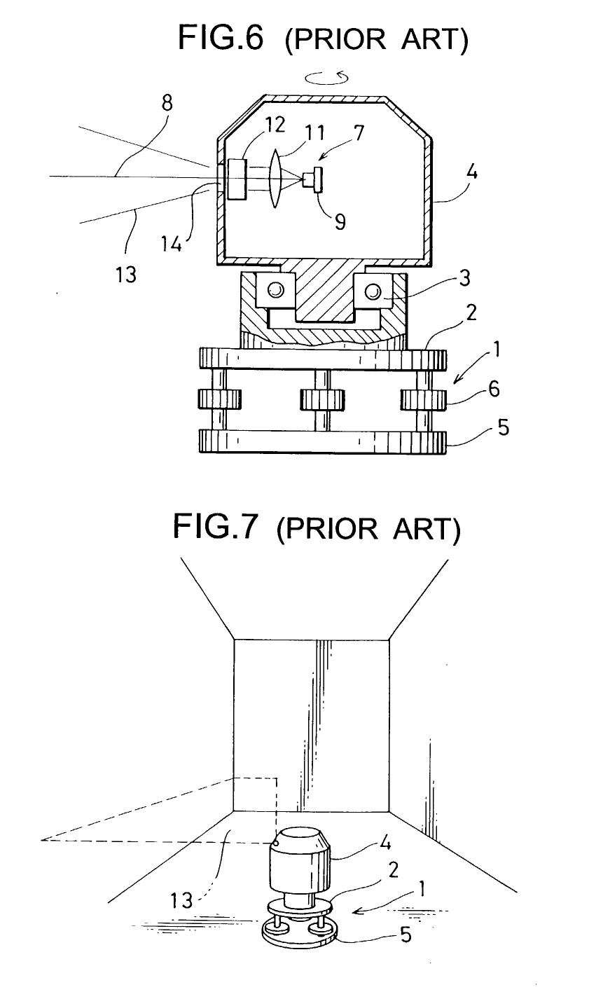

As the leveling unit 15, a manually-operated leveling unit as shown in FIG. 6 may be used.

FIG. 2 represents a variation of the first embodiment shown in FIG. 1.

The same component as in FIG. 1 is referred by the same symbol, and detailed description is not given here.

A driven gear 61 is arranged on the lower end of the rotator holder 48. A driving gear 62 is engaged with the driven gear 61, and the driving gear 62 is engaged on an output shaft of a rotation motor 63.

When the rotation motor 63 is driven, the rotator 58 is rotated. The projecting direction of the laser beam is changed, and the position of the horizontal reference plane or the horizontal reference line is changed.

In this variation, if it is designed in such manner that the laser sighting device is provided with a remote-control function and the rotation motor 63 is driven by a remote controller, it is possible to change the position of the horizontal reference plane or the horizontal reference line by the remote controller from an operating site. This eliminates the problems such as stopping of operation and rotating the rotator 58 of the laser sighting device in order to change the position of the horizontal reference plane or the horizontal reference line. Thus, this contributes to higher working efficiency.

If the rotation motor 63 is replaced with a pulse-control type motor such as a servo motor, a stepping motor, etc. or with a combination of a DC motor and an encoder, it makes it easier to control the rotation angle and to maintain the projecting direction. If the stepping motor is used, it contributes to the reduction of the cost. If the servo motor or the combination of the DC motor and the encoder is used, smooth rotation can be assured.

Also, the rotator holder 48 may be continuously rotated by the rotation motor 63, or reciprocal scanning may be performed at a predetermined angle, and the horizontal reference plane and the horizontal reference line may be formed. In this case, the rod lens 41 may not be used.

It is needless to say that a vertical reference plane or a vertical reference line can be formed if the main unit 16 can be installed at a position by turning it down at an angle of 90° from the position shown in FIG. 1.

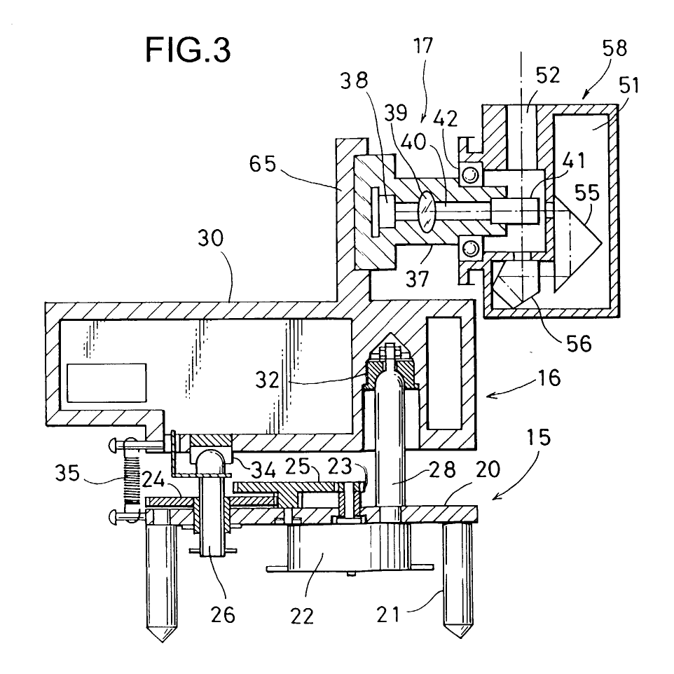

FIG. 3 shows a second variation of the first embodiment.

The second variation is designed so that the vertical reference plane and the vertical reference line can be formed. The same component as in the first embodiment shown in FIG. 1 is referred by the same symbol. The leveling unit 15 and the laser beam projecting unit 17 have the same structures as those shown in the first embodiment, and detailed description is not given here.

A holding baseplate 65 is erected on the upper surface of the frame 30. On the holding baseplate 65, the laser beam projecting unit 17 is fixed by a faucet joint method. It is designed in such manner that the emitted light optical axis 40 of the laser light source 38 is set in a horizontal direction when the laser beam projecting unit 17 is fixed on the holding baseplate 65 and leveling operation by the leveling unit 15 has been completed.

The optical path deflecting component comprising the corner prism 55 and the pentagonal prism 56 deflects and emits the incident light to a direction perpendicular to the incident direction. By maintaining the emitted light optical axis 40 in a horizontal direction, it is possible to always form a vertical reference plane and a vertical reference line accurately.

By adequately rotating the rotator 58, it is possible to change the direction of the vertical reference plane to be formed.

In this case also, the driven gear 61, the driving gear 62, and the rotation motor 63 as shown in FIG. 2 may be provided, and the rotator 58 can be rotated by the rotation motor 63.

In FIG. 3, if a mounting unit is provided so that the emitted light optical axis 40 of the laser beam projecting unit 17 runs in a vertical direction on the frame 30 and the laser beam projecting unit 17 can be removed or inserted, it is possible to form the horizontal reference plane and the vertical reference plane by changing the mounting posture of the laser beam projecting unit 17.

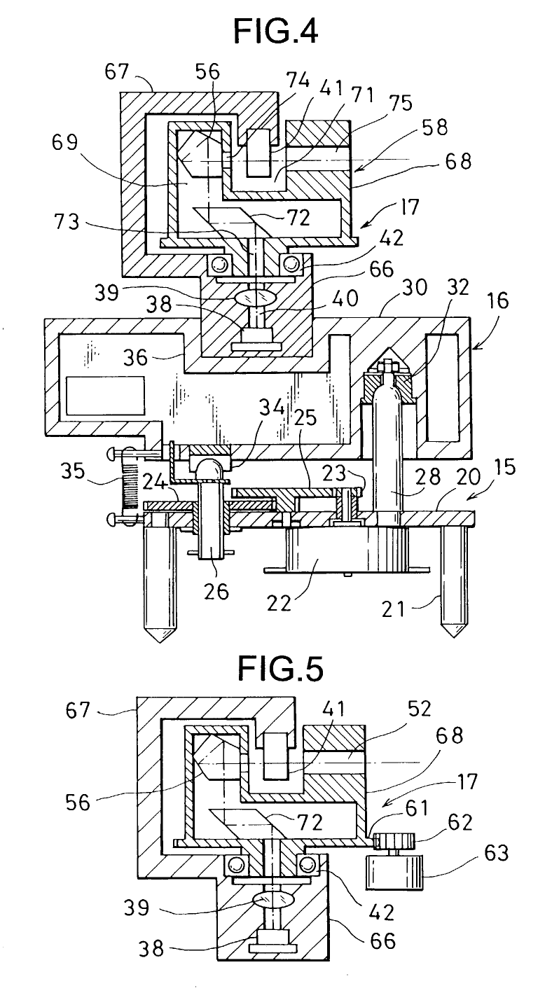

Referring to FIG. 4, description will be given on a second embodiment of the invention.

In FIG. 4, the same component as shown in FIG. 1 of the first embodiment is referred by the same symbol. In particular, the leveling unit 15 has the same structure as that of the first embodiment, and detailed description is not given here.

The laser beam projecting unit 17 is engaged and fitted in the frame 30.

Description will be given on the laser beam projecting unit 17.

A light emitter holder 66 is engaged and fitted in an engaging recess 36 formed on the upper surface of the frame 30. The light emitter holder 66 holds a laser light source 38 and a collimator lens 39, and the laser light source 38 and the collimator lens 39 have an emitted light optical axis 40 extending in a vertical direction. The light emitter holder 66 has a curved arm portion 67 with C-shape, which comprises a lower horizontal portion, a vertical portion and an upper horizontal portion. A rod lens 41 is vertically arranged on the forward end of the arm portion 67. The central line of the rod lens 41 is aligned with an extension of the emitted light optical axis 40.

A rotator holder 68 is rotatably mounted on upper portion of the light emitter holder 66 via bearings 42. A cylindrical recess 71 coaxial with the rotation center is formed in upper portion of the rotator holder 68, and the rod lens 41 is accommodated in the recess 71. A shaft portion is formed in the lower portion of the rotator holder 68, and an optical path hole 73 is formed in the shaft portion. The shaft portion and the optical path hole 73 are positioned on the extension of the emitted light optical axis 40, i.e. on the rotation center of the rotator holder 68.

A prism accommodating unit 69 is formed in the rotator holder 68, and a rhombic prism 72 and a pentagonal prism 56 are accommodated in the prism accommodating unit 69. The rhombic prism 72 and the pentagonal prism 56 make up together an optical path deflecting component.

One reflection surface of the rhombic prism 72 is provided so as to be adjacent to the optical path hole 73, and the pentagonal prism 56 faces toward the other reflection surface of the rhombic prism 72. On a line running perpendicularly to the central line of the rod lens 41 of the rotator holder 68, an optical path hole 74 and a light exit hole 75 are formed.

With the light emitter holder 66 engaged and fitted in the frame 30, the emitted light optical axis 40 runs in a vertical direction when the main unit 16 is adjusted by leveling operation.

When the laser light source 38 is driven and a laser beam is projected, the beam is turned to a parallel beam by the collimator lens 39 and the beam enters the rhombic prism 72. The incident laser beam is reflected by one reflection surface and by the other reflection surface of the rhombic prism 72 and is projected. The optical axis of the projected laser beam from the rhombic prism 72 runs in parallel to the incident light optical axis regardless of the angle of the incident light.

The laser beam projected from the rhombic prism 72 enters the pentagonal prism 56, and the laser beam is deflected at an angle of 90° and is projected. After passing through the rod lens 41, the beam is turned to a fan-shaped light beam and is projected through the light exit hole 75. By the laser beam, a fan-shaped horizontal reference plane is formed. When the laser beam is projected to an object such as wall, a horizontal reference line is formed.

When the position of the horizontal reference plane or the horizontal reference line is to be changed, the rotator 58 is rotated manually at an adequate angle. The projecting direction of the laser beam is changed, and the position of the horizontal reference plane or the horizontal reference line is changed.

The rotator 58 is rotated via the bearings 42. Even when the incident angle of the laser beam to the rhombic prism 72 is slightly changed due to the backlash of the bearings 42, the exit laser beam runs parallel to the emitted light optical axis 40. The pentagonal prism 56 projects the laser beam always in a direction perpendicular to the emitted light optical axis 40. Accordingly, if the main unit 16 is leveled by the leveling unit 15 so that the emitted light optical axis 40 runs in a vertical direction, the horizontal reference plane can be obtained at all times regardless of the backlash of the bearings 42.

FIG. 5 shows a variation of the second embodiment.

In the variation of the second embodiment, a driven gear 61 is formed on the lower end of the rotator holder 68. A driving gear 62 engaged with the driven gear 61 is designed as rotatable by a rotation motor 63, and the rotator holder 68 is rotated by the rotation motor 63.

As the rotation motor 63, it is preferable to use a pulse-control type servomotor, a stepping motor, or a combination of a DC motor and an encoder. It is the same as the description of FIG. 2. It is needless to say that a vertical reference plane and a vertical reference line can be formed if the main unit 16 can be installed by turning it down by an angle of 90° from the position shown in FIG. 4.

Further, if the laser beam projecting unit 17 is mounted by changing the posture at an angle of 90° with respect to the main unit 16, the vertical reference plane and the vertical reference line can be formed. This is the same as the case shown in FIG. 3.

According to the present invention, a laser sighting device comprises a light emitter holder, a rotator holder rotatably mounted on the light emitter holder, a laser light source mounted on the light emitter holder and for emitting a laser beam on an emitted light optical axis along a rotation center of the rotator holder, and an optical path deflecting component mounted on the rotator holder and for deflecting the laser beam projected from the laser light source in a direction perpendicular to the emitted light optical axis. As a result, the projected laser beam runs in a direction perpendicular to the emitted light optical axis of the laser beam regardless of error in the rotator. By maintaining the emitted light optical axis in a vertical direction or in a horizontal direction, it is possible to form an accurate horizontal reference plane or an accurate vertical reference plane.

What is claimed is:

1. A laser sighting device, comprising a light emitter holder, a rotator holder rotatably mounted on said light emitter holder, a laser light source mounted on said light emitter holder and for emitting a laser beam on an emitted light optical axis along a rotation center of said rotator holder, and an optical path deflecting component mounted on said rotator holder and for deflecting the laser beam projected from said laser light source in a direction perpendicular to said emitted light optical axis.

2. A laser sighting device according to claim 1, wherein said light emitter holder comprises a rod lens on the rotation center of said rotator holder, and the laser beam deflected by the optical path deflecting member is entered in a direction perpendicular to the center line of said rod lens.

3. A laser sighting device according to claim 2, wherein said optical path deflecting component deflects the laser beam to a perpendicular direction after the laser beam passes through said rod lens in parallel to the center line.

4. A laser sighting device according to claim 2, wherein said optical path deflecting component deflects the laser beam coming from said laser light source in a perpendicular direction and then enters the laser beam toward said rod lens.

5. A laser sighting device according to claim 1, wherein said optical path deflecting component comprises a corner prism and a pentagonal prism.

6. A laser sighting device according to claim 1, wherein said optical path deflecting component comprises a rhombic prism and a pentagonal prism.

7. A laser sighting device according to claim 1, wherein there is further provided a leveling unit, and said light emitter holder is arranged in a direction perpendicular to a horizontal plane leveled by said leveling unit.

8. A laser sighting device according to claim 1, wherein there is further provided a leveling unit, and said light emitter holder is arranged in parallel to a horizontal plane leveled by said leveling unit.

9. A laser sighting device according to claim 1, wherein there is provided a rotating means for rotating said rotator holder.
